(19) United States
(12) Patent Application Publication
(10) Pub. No.: US 2013/0164983 A1
(43) Pub. Date: Jun. 27, 2013

(54) CONNECTOR AND ELECTRONIC DEVICE HAVING SAME

(71) Applicant: Lotes Co., Ltd., Keelung (TW)

(72) Inventor: Ted Ju, Keelung (TW)

(73) Assignee: LOTES CO., LTD., Keelung (TW)

(21) Appl. No.: 13/724,210

(22) Filed: Dec. 21, 2012

(30) Foreign Application Priority Data
Dec. 22, 2011 (CN) 201120541674.4

(51) Int. Cl. H01R 13/6581

(52) U.S. Cl. CPC H01R 13/6581
USPC 439/607.55

(57) ABSTRACT

An electrical connector is used in a thin electronic device. The electrical connector has an insulating body and a plurality of conductive terminals. A front side of the electrical connector is used for inserting a mating connector. A casing of the thin electronic device is used to provide at least partial electromagnetic shielding for the electrical connector, so that a part of a metal shell does not need to be provided on the electrical connector, thereby effectively reducing the space occupied by the thin electronic device.

### CROSS-REFERENCE TO RELATED APPLICATION

This application claims priority to and the benefit of, pursuant to 35 U.S.C. §119(a), Patent Application No. 201120541674.4 filed in P.R. China on Dec. 22, 2011, the disclosure of which is incorporated herein in its entirety by reference.

### FIELD OF THE INVENTION

The present invention relates generally to an electrical connector and an electronic device using the same, and more particularly to an electrical connector and a thin electronic device using the same.

### BACKGROUND OF THE INVENTION

To meet the requirement for portability, nowadays thin electronic devices such as notebook computers are developing toward thinner structures. To achieve this objective, various chips in a thin electronic device are directly soldered to a circuit board, rather than being electrically connected to the circuit board through electrical connectors as before. However, some electrical connectors, particularly input/output connectors such as a Universal Serial Bus (USB) connector are indispensable, which becomes a bottleneck in the development of thinner electronic devices. Hence, how to design an electrical connector that occupies a smaller height space is a problem to be solved in the industry.

In some cases, the horizontal space is small, and it is required to reduce the width of the electrical connector as much as possible, so that it will occupy a smaller horizontal space.

Therefore, it is necessary to design a novel electrical connector and a thin electronic device using the same to solve the above problems.

### SUMMARY OF THE INVENTION

In one aspect, the present invention is directed to an electrical connector that occupies a smaller space and a thin electronic device using the same.

In one embodiment, an electrical connector, used in a thin electronic device, has an insulating body and a plurality of conductive terminals. A front side of the electrical connector is used for a mating connector to be inserted therein. The electrical connector includes a metal shell disposed at left and right sides of the insulating body to provide electromagnetic shielding. A casing of the thin electronic device is used at an upper side or a lower side of the insulating body to provide electromagnetic shielding for the electrical connector.

In one embodiment, a USB electrical connector is disposed in an electronic device. The USB electrical connector has an insulating body and USB terminals. The USB electrical connector is used for a mating connector to be inserted therein. At least partially around the USB electrical connector, a metal shell for electromagnetic shielding is not disposed, and a conductive casing of the electronic device is used to provide electromagnetic shielding for the USB electrical connector.

In one embodiment, a thin electronic device includes an electrical connector having an insulating body and a plurality of conductive terminals. The electrical connector is used for a mating connector to be inserted therein. A casing of the thin electronic device is used to provide at least partial electromagnetic shielding for the electrical connector.

Further, the casing includes an upper casing and a lower casing. At least one of the upper casing and the lower casing is made of a conductive material to provide electromagnetic shielding for the electrical connector.

Further, at least one of the upper casing and the lower casing extends to form an opening made of a conductive material to surround the electrical connector, so as to provide electromagnetic shielding for the electrical connector.

Further, the casing further includes a guide portion, to facilitate insertion of the mating connector into the electrical connector.

Further, the thin electronic device further includes a support portion for providing a sufficient support force to support the electrical connector when the mating connector is inserted.

Further, the electrical connector includes a conductive elastic piece conducted to a circuit board. When the mating connector is inserted into the electrical connector, the conductive elastic piece contacts the mating connector. The electrical connector may further includes a conducting portion conducted to a circuit board. When the mating connector is inserted into the electrical connector, the conducting portion is conducted to an electromagnetic shielding member of the mating connector.

Still further, the conductive elastic piece is conducted to the circuit board through the casing, so as to achieve an electrostatic protection function.

As compared with the related art, in the electrical connector and the electronic device using the same according to embodiments of the present invention, a casing of the thin electronic device is used to provide at least partial electromagnetic shielding for the electrical connector, so that a part of a metal shell does not need to be provided on the electrical connector, thereby effectively reducing the space occupied by the thin electronic device.

### BRIEF DESCRIPTION OF THE DRAWINGS

FIG. 1 is a three-dimensional exploded view of an electronic device according to a first embodiment of the present invention;

FIG. 2 is a three-dimensional view of an electrical connector in the electronic device shown in FIG. 1;

FIG. 3 is a partial assembled view of the electronic device shown in FIG. 1;

FIG. 4 is a sectional view before a mating connector is inserted into the electronic device shown in FIG. 1;

FIG. 5 is a sectional view after a mating connector is inserted into the electronic device shown in FIG. 1;

FIG. 6 is a partial assembled view of an electronic device according to a second embodiment of the present invention; and

FIG. 7 is a three-dimensional exploded view of an electronic device according to a third embodiment of the present invention.

Reference numbers in the first embodiment and the second embodiment:

| | | | | | |
|---|---|---|---|---|---|
| casing | 1 | upper casing | 11 | upper body | 111 |
| front upper body | 113 | front upper opening | 115 | upper sidewall | 117 |
| lower casing | 13 | lower body | 131 | front lower body | 133 |
| front lower opening | 135 | lower sidewall | 137 | guide portion | 15 |
| support portion | 17 | circuit board | 3 | signal line | 31 |
| ground line | 33 | screw hole | 35 | electrical connector | 5 |
| insulating body | 51 | base | 511 | tongue plate | 513 |
| side arm | 515 | through hole | 517 | terminals | 53 |
| metal shell | 55 | rear shell | 551 | side shell | 553 |
| ground portion | 555 | conductive elastic piece | 57 | conducting portion | 571 |
| screws | 7 | mating connector | 9 | electromagnetic shielding | 91 |
| | | | | member | |

Reference numbers in the third embodiment:

| | | | | | |
|---|---|---|---|---|---|
| casing | 1 | upper casing | 11 | upper body | 111 |
| notch | 119 | lower casing | 13 | lower body | 131 |
| front body | 132 | front opening | 134 | sidewall | 136 |
| upper wall | 138 | circuit board | 3 | signal line | 31 |
| ground line | 33 | screw hole | 35 | electrical connector | 5 |
| insulating | 51 | base | 511 | tongue plate | 513 |
| body | | | | | |
| side arm | 515 | terminals | 53 | metal shell | 55 |
| rear shell | 551 | side shell | 553 | screws | 7 |

### DETAILED DESCRIPTION OF THE INVENTION

The present invention is more particularly described in the following examples that are intended as illustrative only since numerous modifications and variations therein will be apparent to those skilled in the art.

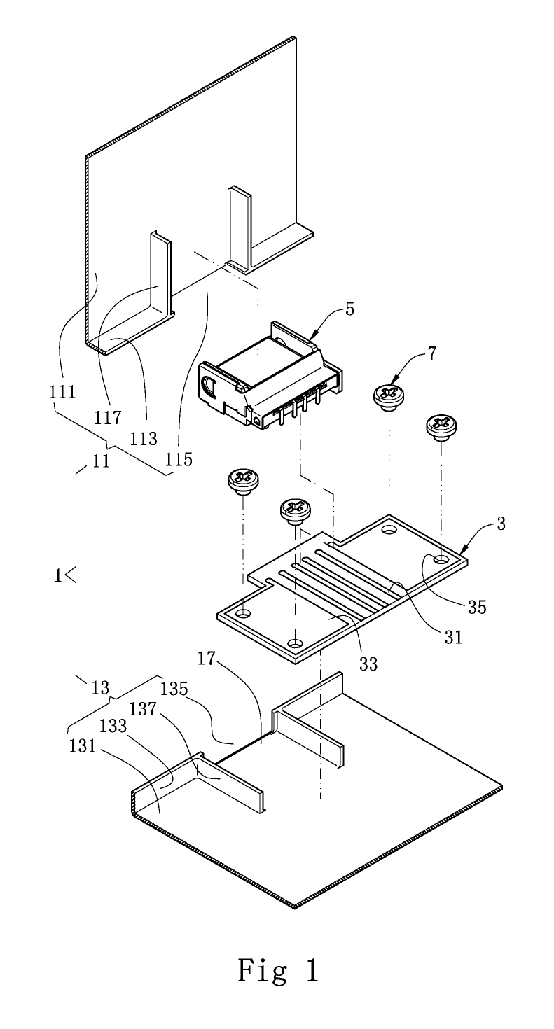

As shown in FIG. 1, according to one embodiment of the present invention, a thin electronic device includes an upper casing 11 and a lower casing 13, which jointly form a casing 1 having an accommodation space. In this embodiment, both the upper casing 11 and the lower casing 13 are made of a conductive material. Alternatively, in other embodiments, only one of the upper casing 11 and the lower casing 13 is made of a conductive material. A circuit board 3 and a USB electrical connector 5 are received in the accommodation space (alternatively, in other embodiments, applicable electrical connectors are not limited to those of the USB specification). The circuit board 3 is attached to the lower casing 13 through screws 7.

The upper casing 11 includes an upper body 111 and a front upper body 113. The front upper body 113 is provided with a front upper opening 115 facing downward. Two sides of the front upper opening 115 respectively extend backward to form upper sidewalls 117. The distance between the two upper sidewalls 117 is slightly greater than the width of the electrical connector 5.

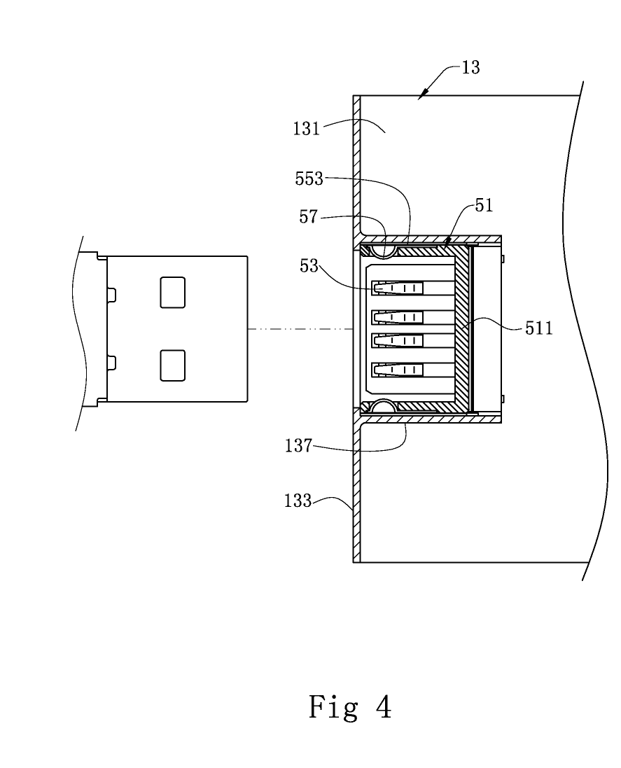

The lower casing 13 includes a lower body 131 and a front lower body 133. The front lower body 133 is provided with a front lower opening 135 facing upward. Two sides of the front lower opening 135 respectively extend backward to form lower sidewalls 137. The front lower opening 135 and the front upper opening 115 have the same width, and may jointly define an opening (not marked) through which a mating connector 9 (as shown in FIG. 4) is inserted into the electrical connector 5. A support portion 17 is further disposed at a lower edge of the front lower opening 135 to provide a sufficient support force to support the electrical connector 5 when the mating connector 9 is inserted. Alternatively, the support portion 17 may be disposed on the electrical connector 5 or the circuit board 3. The two lower sidewalls 137 and the two upper sidewalls 117 are corresponding to one another, jointly defining a receiving space for receiving the electrical connector 5.

The upper casing 11 and the lower casing 13 are jointly provided with a guide portion 15, to facilitate insertion of the mating connector 9 into the electrical connector 5.

The circuit board 3 includes a plurality of signal lines 31 for signal transmission and ground lines 33, and is provided thereon with four screw holes 35 for the screws 7 to pass through. The screw holes 35 are connected to the corresponding ground lines 33. The circuit board 3 generally also includes other elements, which are not enumerated herein.

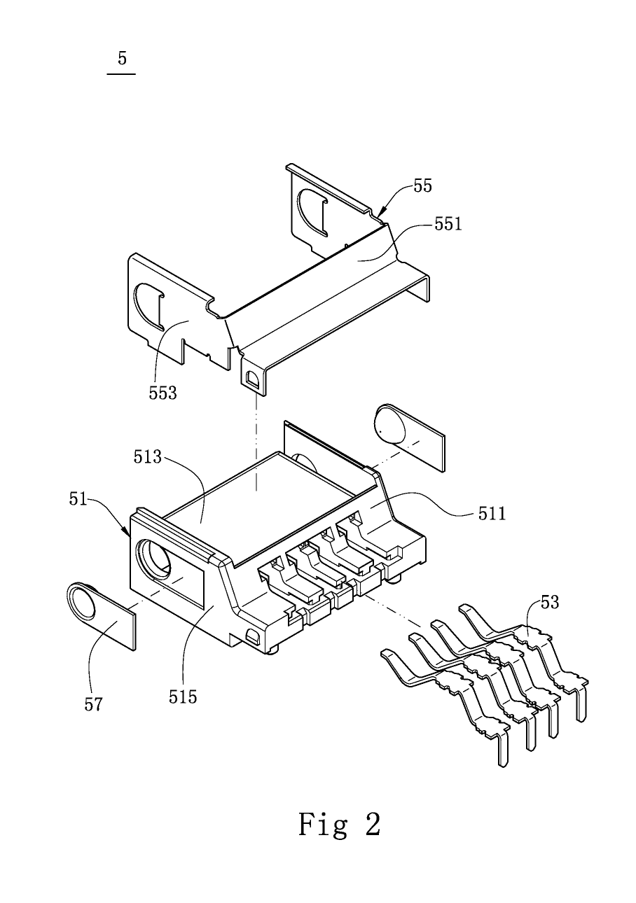

As shown in FIG. 2, the electrical connector 5 has a front side for the mating connector 9 to be inserted therein. The electrical connector 5 includes an insulating body 51 and a plurality of USB terminals 53 fixed to the insulating body 51. The insulating body 51 includes a base 511, a tongue plate 513 extending forward from the middle of a front end of the base 511, and side arms 515 extending forward from two sides of the front end of the base 511. A front end of each of the side arms 515 is provided with a through hole 517. The electrical connector 5 further includes a U-shaped metal shell 55, which includes a rear shell 551 wrapping a rear side of the base 511, and side shells 553 extending forward from two sides of the rear shell 551 and wrapping the side arms 515. A conductive elastic piece 57 electrically connected to the side shell 553 is further disposed between the side shell 553 and the side arm 515. The conductive elastic piece 57 includes a conducting portion 571 passing through the through hole 517 and used to contact an electromagnetic shielding member 91 of the mating connector 9 when the mating connector 9 is inserted into the electrical connector 5. The conductive elastic piece 57 may also be integrally formed with the side shells 553 by stamping and bending (in other embodiments, the metal shell for electromagnetic shielding does not need to be disposed around the USB electrical connector 5).

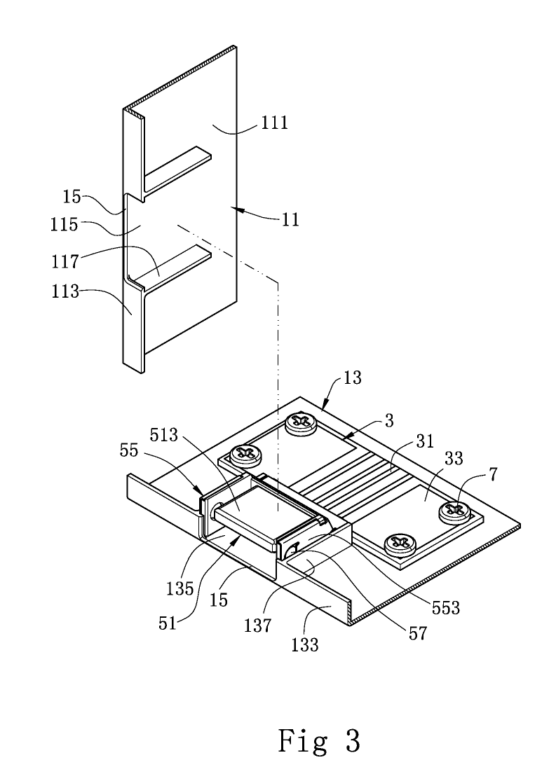

As shown in FIGS. 3-5, after being assembled, the electrical connector 5 is fixed to the circuit board 3 by soldering, and the terminals 53 are connected to the signal lines 31. Then, the two are fixed to the lower casing 13 through the screws 7, and at this time, the electrical connector 5 is half received between the two lower sidewalls 137. Afterward, the upper casing 11 is correspondingly mounted on the lower casing 13, so that the front upper opening 115 and the front lower opening 135 correspond to each other and jointly define an opening through which the mating connector (not shown) is inserted into the electrical connector 5, and the upper sidewalls 117 and the lower sidewalls 137 correspond to one another and completely receive the electrical connector 5.

The upper sidewalls 117 and the lower sidewalls 137 contact the side shells 553. When the mating connector 9 is inserted into the electrical connector 5, the electromagnetic shielding member 91 of the mating connector 9 contacts the conductive elastic pieces 57, and the conductive elastic pieces 57 are conducted to the casing 1 (specifically, the upper sidewalls 117 and/or the lower sidewalls 137, where if the upper sidewalls 117 or the lower sidewalls 137 are conductive, the conductive elastic pieces 57 are conducted to the conductive elements) through the metal shell 55 (specifically, the side shells 553), and are then connected to the ground lines 33 through the screws 7 and the screw holes 35 and thus conducted to the circuit board 3, thereby achieving an electrostatic protection effect.

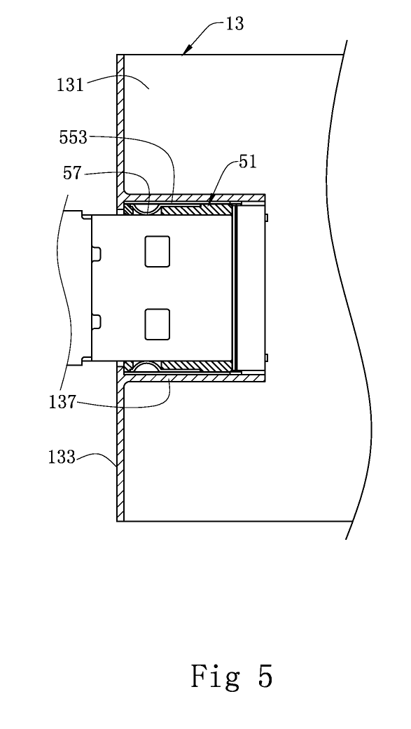

Conduction of the conductive elastic pieces 57 to the circuit board 3 is not limited to the above method, but may also be achieved by other methods. For example, as shown in FIG. 5, a ground portion 555 is disposed at a rear portion of the metal shell 55 and corresponding to the ground lines 33. When the mating connector 9 is inserted, the electromagnetic shielding member 91 of the mating connector 9 contacts the conductive elastic pieces 57, and the conductive elastic pieces 57 are sequentially connected to the circuit board 3 (specifically, the ground lines 33) through the metal shell 55 (specifically, the side shells 553 and the ground portion 555), which also can achieve an electrostatic protection function.

In the above embodiment, the metal shell 55 is used to provide electromagnetic shielding for the left and right sides of the insulating body 51, and the casing 1 is used to provide electromagnetic shielding for the upper and lower sides of the insulating body 51. In this way, since the metal shell does not need to be disposed in the vertical direction of the electrical connector 5, the height space occupied by the electrical connector 5 can be reduced, so that the height of the thin electronic device is reduced, thereby making the thin electronic device thinner to meet the requirement for portability better. If only one of the upper casing 11 and the lower casing 13 is conductive, the metal shell does not need to be disposed at the upper or lower side of the electrical connector 5, so that the height space occupied by the electrical connector 5 can be reduced.

Meanwhile, since the casing 1 has the upper sidewalls 117 and the lower sidewalls 137, the metal shell 55 does not need to be provided on the insulating body 51, and instead, electromagnetic shielding in the horizontal direction of the insulating body 51 is provided by the casing 1, that is, the upper sidewalls 117 and the lower sidewalls 137. In this way, the height and horizontal spaces occupied by the electrical connector 5 can be reduced at the same time. In this case, the electrostatic protection effect may be achieved by using the electromagnetic shielding member 91 of the mating connector 9 to contact the casing 1 which is then connected to the circuit board 3.

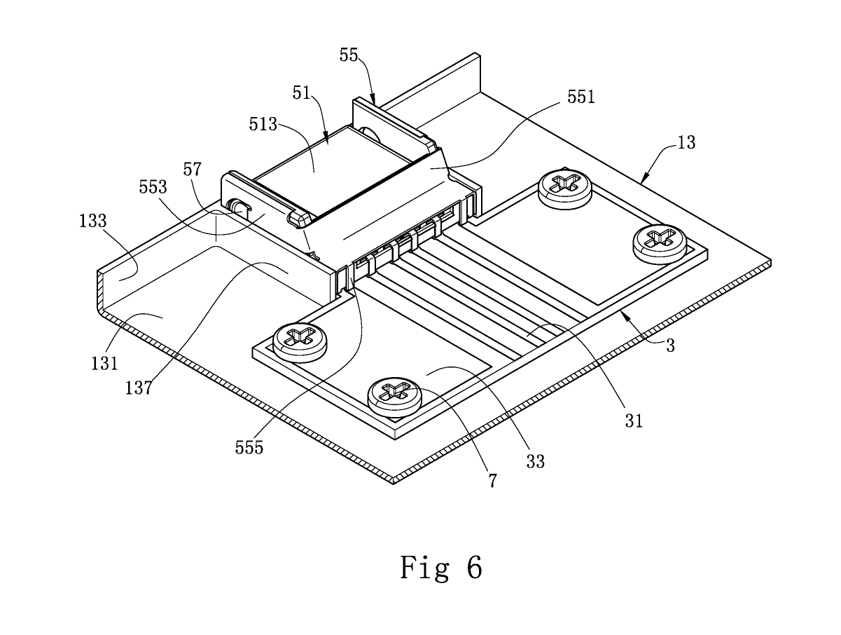

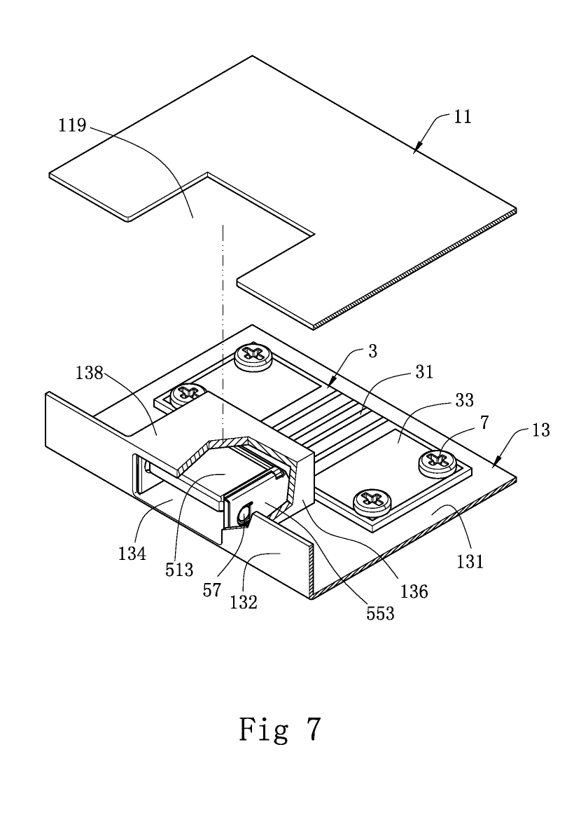

In the above embodiment, the electrical connector 5 is shielded in the vertical direction by the upper and lower casings, but may also be shielded by one of the upper and lower casings as shown in FIG. 6 and FIG. 7. Referring to FIG. 6 and FIG. 7, the upper casing 11 does not have the front upper body 113 but only has an upper body 111, and the upper body 111 is provided with a notch 119 at a front portion thereof. The lower casing 13 includes a lower body 131 and a front body 132, and the front body 132 is provided with a front opening 134. Around the front opening 134, the lower casing 13 further has two sidewalls 136 and an upper wall 138. The two sidewalls 136, the upper wall 138 and the lower body 131 jointly define a receiving space for receiving the electrical connector 5. In this way, the lower casing 13 can shield the electrical connector 5 independently. Other structures may be the same as that of the above embodiment, and will not be described in detail herein again.

In other embodiments, the casing 1 may only shield the left and right sides of the electrical connector 5, so as to reduce the horizontal space occupied by the electrical connector 5. Further, to adapt to different cases, the casing 1 may shield any one or more sides of the electrical connector 5, so as to reduce the corresponding space occupied by the electrical connector 5.

Based on the above, the electrical connector and the electronic device using the same according to embodiments of the present invention have the following beneficial effect: a casing of the thin electronic device is used to provide at least partial electromagnetic shielding for the electrical connector, so as to reduce the corresponding space occupied by the electrical connector.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, used in a thin electronic device, and having an insulating body and a plurality of conductive terminals,
wherein a front side of the electrical connector is used for a mating connector to be inserted therein;
wherein the electrical connector comprises a metal shell disposed at left side and right side of the insulating body to provide electromagnetic shielding; and
wherein a casing of the thin electronic device is used at an upper side or a lower side of the insulating body to provide electromagnetic shielding for the electrical connector.

2. The electrical connector according to claim 1, wherein the casing comprises an upper casing and a lower casing, and at least one of the upper casing and the lower casing is made of a conductive material to provide electromagnetic shielding for the electrical connector.

3. The electrical connector according to claim 1, wherein at least one of the upper casing and the lower casing extends to form an opening made of a conductive material to surround the electrical connector, so as to provide electromagnetic shielding for the electrical connector.

4. The electrical connector according to claim 1, wherein the casing further comprises a guide portion to facilitate insertion of the mating connector into the electrical connector.

5. The electrical connector according to claim 1, further comprising a support portion for supporting the electrical connector when the mating connector is inserted therein.

6. The electrical connector according to claim 1, further comprising a conductive elastic piece conducted to a circuit board, wherein when the mating connector is inserted into the electrical connector, the conductive elastic piece contacts the mating connector.

7. The electrical connector according to claim 6, wherein the conductive elastic piece is conducted to the circuit board through the casing.

8. A Universal Serial Bus (USB) electrical connector, disposed in a thin electronic device, having an insulating body and USB terminals, and for a mating connector to be inserted therein,
wherein at least partially around the USB electrical connector, a metal shell for electromagnetic shielding is not disposed, and a conductive casing of the thin electronic device is used to provide electromagnetic shielding for the USB electrical connector.

9. The USB electrical connector according to claim 8, wherein the casing comprises an upper casing and a lower casing, and at least one of the upper casing and the lower casing is made of a conductive material to provide electromagnetic shielding for the USB electrical connector.

10. The USB electrical connector according to claim 8, wherein at least one of the upper casing and the lower casing extends to form an opening made of a conductive material to surround the USB electrical connector, so as to provide electromagnetic shielding for the USB electrical connector.

11. The USB electrical connector according to claim 8, further comprising a support portion for providing a sufficient support force when the mating connector is inserted therein.

12. The USB electrical connector according to claim 8, further comprising a conducting portion conducted to a circuit board, wherein when the mating connector is inserted into the USB electrical connector, the conducting portion is conducted to an electromagnetic shielding member of the mating connector.

13. The USB electrical connector according to claim 12, wherein the conducting portion is conducted to the circuit board through the casing.

14. A thin electronic device, comprising an electrical connector having an insulating body and a plurality of conductive terminals, wherein the electrical connector is used for a mating connector to be inserted therein, and a casing of the thin electronic device is used to provide at least partial electromagnetic shielding for the electrical connector.

15. The thin electronic device according to claim 14, wherein the casing comprises an upper casing and a lower casing, and at least one of the upper casing and the lower casing is made of a conductive material to provide electromagnetic shielding for the electrical connector.

16. The thin electronic device according to claim 14, wherein at least one of the upper casing and the lower casing extends to form an opening made of a conductive material to surround the electrical connector, so as to provide electromagnetic shielding for the electrical connector.

17. The thin electronic device according to claim 14, wherein the casing further comprises a guide portion to facilitate insertion of the mating connector into the electrical connector.

18. The thin electronic device according to claim 14, further comprising a support portion for supporting the electrical connector.

19. The thin electronic device according to claim 14, further comprising a conducting portion conducted to a circuit board, wherein when the mating connector is inserted into the electrical connector, the conducting portion is conducted to an electromagnetic shielding member of the mating connector.

20. The thin electronic device according to claim 19, wherein the conductive portion is conducted to the circuit board through the casing.
